(19) United States
(12) Patent Application Publication
(10) Pub. No.: US 2021/0258505 A1
(43) Pub. Date: Aug. 19, 2021

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Takehiro Yoshida, Tokyo (JP); Yusuke Shirakawa, Kanagawa (JP); Yusuke Haruyama, Tokyo (JP)

(21) Appl. No.: 17/307,836

(22) Filed: May 4, 2021

Related U.S. Application Data
(63) Continuation of application No. PCT/JP2019/040876, filed on Oct. 17, 2019.

(30) Foreign Application Priority Data
Nov. 7, 2018 (JP) 2018-209518

(51) Int. Cl. H04N 5/232; G06K 9/00; H04N 5/247

(52) U.S. Cl. CPC H04N 5/232945; H04N 5/247; G06K 9/00671

(57) ABSTRACT

When a professional photographer or a general spectator acquires a video, position information of a specific target corresponding to a password is displayed in a timely manner.

An image processing apparatus includes display unit for displaying an image, selection unit for selecting a specific target from the image displayed on the display unit, designation information generation unit for generating designation information regarding the specific target selected by the selection unit, transmission unit for transmitting the designation information generated by the designation information generation unit and a predetermined password to a server, acquisition unit for acquiring position information of the specific target that is generated by the server on the basis of the designation information and the password from the server, and control unit for displaying additional information based on the position information of the specific target acquired by the acquisition unit on the display unit.

### CROSS-REFERENCE OF RELATED APPLICATIONS

This application is a continuation of International Patent Application No. PCT/JP2019/040876, filed on Oct. 17, 2019, which claims the benefit of Japanese Patent Application No. 2018-209518, filed on Nov. 7, 2018, both of which are hereby incorporated by reference herein their entirety.

### BACKGROUND

### Field

The present disclosure relates to an image processing apparatus and the like for imaging or video monitoring.

In recent years, internationalization has progressed, and many tourists are visiting Japan. In competitive sports as well, photographic opportunities for players from various countries are increasing significantly.

However, it is relatively difficult for both professional photographers and those who take ordinary pictures to find a specific player among a large number of players in a competitive sports scene, for example. Especially, during competitions in competitive sports, there are many cases where a plurality of players moves fast and cross each other and thus a place where a player is located is lost sight of. The same can be said not only for competitive sports but also for imaging or monitoring a specific person in the crowd.

Japanese Patent Laid-Open No. 2017-211828 discloses a plurality of cameras that image a subject from a plurality of directions and a plurality of image processing apparatuses that extract a predetermined region from a captured image obtained by a corresponding camera among the plurality of cameras. Japanese Patent Laid-Open No. 2017-211828 also discloses an image generation apparatus that generates a virtual viewpoint image on the basis of image data of the predetermined region extracted from captured images obtained by the plurality of cameras by the plurality of image processing apparatuses.

Japanese Patent No. 5322629 discloses an automatic focus detector that drives a focus lens on the basis of an AF evaluation value acquired from a captured image and performs automatic focus detection control.

However, if many players are gathering, such as in a sports scene, the players may overlap and a player may be lost sight of. It may be difficult to image a player at the right time because the player may be out of sight.

Particularly, a professional photographer needs to immediately send a photograph taken to a news office or the like, but there is a drawback that it takes time to recognize a determination if a determination result is not known. Even if a player desired to be imaged is found, a photographer has to pursue the player desired to be imaged after focusing on that player. There is a disadvantage that pursuing is very difficult in fast-moving sports, and, if the photographer concentrates on this pursuit, the photographer may not be able to take good pictures.

A server side can ascertain various information regarding a game or a competition field from omnidirectional videos, and can thus acquire various valuable information from inside and outside a ground, but there is a problem in that a system of the related art does not fully utilize a server.

Similarly, general users who monitor competitions in a stadium or at home terminals often lose sight of a specific player or lose track of a competition status. Similarly, in car races, airplane races, horse races, or the like, a target such as a specific vehicle, airplane, or horse, may be lost sight of. Even if a specific person is tracked on a street corner, the specific person may be sometimes lost in the crowd.

If the visual pursuit of a specific target to which attention is being paid is concentrated upon, there may be a problem that the target may not be able to be smoothly imaged or focused upon, or the exposure for a target may not be able to be smoothly adjusted.

There is a need in the art to solve the above problems and to provide an image processing apparatus capable of displaying information valuable to an imager or an observer in a timely manner according to a password.

### SUMMARY

According to an embodiment of the present disclosure, there is provided an image processing apparatus that includes:

at least one processor or circuit configured to function as:

a display unit configured to display an image:

a selection unit configured to select a specific target from the image displayed on the display unit;

a designation information generation unit configured to generate designation information regarding the specific target selected by the selection unit;

a transmission unit configured to transmit the designation information generated by the designation information generation unit and a predetermined password to a server;

an acquisition unit configured to acquire position information of the specific target that is generated by the server on the basis of the designation information and the password from the server; and

a control unit configured to display additional information based on the position information of the specific target acquired by the acquisition unit on the display unit.

Further features of the present disclosure will become apparent from the following description of exemplary embodiments with reference to the attached drawings.

### BRIEF DESCRIPTION OF DRAWINGS

FIG. 1 is a block diagram of the overall system including an image processing apparatus of an Embodiment.

FIG. 2 is a detailed block diagram of a server side.

FIG. 3 is a detailed block diagram of a terminal side.

FIG. 4 is a detailed block diagram of the terminal side.

FIG. 5A illustrates a sequence in which the server 110 side answers a question (request) from the camera 500 side. FIG. 5B illustrates a sequence in which the camera 500 as a terminal makes inquiries (requests) to the server 110 many times.

FIG. 6 is a diagram illustrating an example of a player of interest display tracking sequence.

FIG. 7A is a diagram illustrating a player of interest display tracking control flow in the camera side. FIG. 7B illustrates an example of a flow related to S107-2 of displaying a mark.

FIG. 8 is a diagram illustrating another example of a player of interest display tracking control flow in the camera side.

FIG. 9 is a block diagram illustrating a functional configuration example of a tracking unit 371 of a digital camera.

FIG. 10 is a diagram illustrating a player of interest detection control flow in the server side.

FIG. 11 is a diagram illustrating a flow for detecting a uniform number of a player in the server side.

FIG. 12 is a diagram illustrating an example of a player of interest detection control flow.

FIG. 13 is a diagram illustrating an example of a detection control flow for a player of interest in a field.

FIG. 14 is a diagram illustrating an example of a detection control flow for a player of interest in a field.

FIG. 15 is a diagram illustrating an example of a detection control flow for a player of interest in a field.

FIG. 16 is a diagram illustrating an example of a detection control flow for a player of interest in a field.

FIG. 17A illustrates a detection control flow for a player of interest outside the field in S2013. FIG. 17B illustrates a detection control flow for a player of interest outside the field using uniform number information in the server side. FIG. 17C is a diagram in which S2501 in FIG. 17A is replaced with S2701. FIG. 17D is a diagram in which S2501 in FIG. 17A is replaced with S2801.

FIG. 18 is a diagram illustrating an example of a control sequence for an absolute position and a relative position.

FIG. 19 is a diagram illustrating an example of a control sequence for an absolute position and a relative position.

FIG. 20 is a diagram illustrating an example of a player of interest display control flow.

FIG. 21 is a diagram illustrating an example of a player of interest display control flow.

FIG. 22 is a diagram illustrating an example of a player of interest display control flow.

FIG. 23 is a diagram illustrating an example of a player of interest display control flow.

### DESCRIPTION OF THE EMBODIMENTS

Hereinafter, an embodiment of the present disclosure will be described using Embodiments.

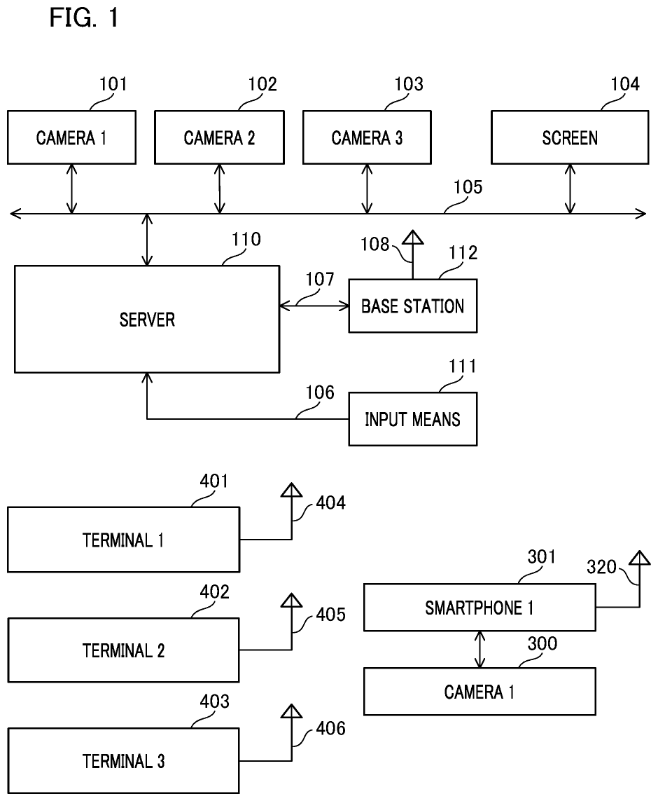

First, the overall system image using an image processing apparatus for supporting imaging or video monitoring will be described with reference to FIG. 1.

In FIG. 1, a server (image processing server) side, which has a plurality of cameras (for example, fixed cameras or mobile cameras using drones) for the server, ascertains a position of a player of interest (specific target) or the latest status of a game in the entire field of a stadium in real time. A description will be made of an example in which the server provides necessary information, for example, during camera imaging or image monitoring to a terminal owned by each of spectators in a timely manner.

Generally, there are many places that professional photographers or general photographers are unable to see or follow at an angle or a field of view at which a camera is performing imaging. This is also the same for spectators who are outside a stadium and are not performing imaging. On the other hand, a system of the server side can ascertain and map omnidirectional videos and information (field coordinate information or the like) regarding the entire field of a game in advance on the basis of videos from a plurality of cameras for the server.

Therefore, a service to spectators can be greatly improved by the server ascertaining and distributing information that is difficult to understand and cannot be seen by each of users.

In other words, the plurality of cameras (fixed cameras or mobile cameras) for the server can track each player's position, score, and foul, a referee's decision, and other latest statuses. Such information may also be analyzed by the server on the basis of information displayed on a large screen. Consequently, the overall status can be accurately recognized and transmitted in a timely manner to a camera terminal or the like, or a terminal such as a smartphone or a tablet owned by a professional photographer or a spectator

Consequently, the spectator can ascertain the latest status of a competition in a timely manner. Particularly, a professional photographer is required to immediately send a taken picture to a newsroom or the like, but it is difficult to accurately ascertain the overall status of a competition because the field of view is narrow just by looking at a camera screen. However, if the configuration as in the present Embodiment is used, a competition status can be rapidly ascertained, and thus a picture to be sent to a newsroom or the like can be quickly selected.

As a terminal (image processing apparatus) used by a professional photographer or a spectator, a digital camera, a smartphone, a configuration in which a camera and a smartphone are connected, a tablet PC, a TV, or the like may be used. Since the same service can be provided to spectators who are watching the competition through terminals (image processing apparatuses) such as PCs and TVs on the Internet and television broadcasting at home, it is possible to ascertain a situation of the competition more accurately and thus to better enjoy the competition.

In FIG. 1, 101 to 103 denote cameras for the server, and 101 (stationary camera1), 102 (stationary camera2), 103 (stationary camera3), 104 (large screen), 110 (server), 111 (input means), and 112 (base station) acquire videos or acquire sound for providing information to general professional photographers or spectators. The cameras for the server are three cameras such as those of 101 to 103 in the present embodiment, but may be one or plural.

Such a camera for the server may be, for example, a camera mounted on a drone or the like instead of a stationary camera. In addition to video acquisition and sound acquisition, input information (for example, sound) other than videos may be incorporated from the input means to expand services to general professional photographers or spectators.

105 denotes a LAN or the Internet based on wired/wireless communication, and 106 denotes a connection line for inputting information output from the input means 111 to the server 110. 107 denotes a connection line for transmitting and receiving signals to and from the base station 112, and 108 denotes an antenna portion for executing wireless communication of the base station.

In other words, the above blocks with the reference signs 100s are blocks for supporting video capturing of a professional photographer, a general spectator, or the like.

On the other hand, in FIG. 1, 401 (terminal1), 402 (terminal2), and 403 (termnal3) are terminals, and are, for example, video display terminal apparatuses such as cameras, smartphones, tablet PCs, or TVs used for professional photographers or general spectators to perform imaging or monitoring, for example. Here, 404 (antenna), 405 (antenna), and 406 (antenna) are antennae respectively used for wireless communication by 401 (terminal1), 402 (terminal2), and 403 (terminal3).

When the server detects a position of a player of interest, for example, the terminals send ID information or the like of the player of interest to the server side, and the server side sends various information such as position information regarding the player to the terminals. Since players are moving and a competition status is also changing, a process of detecting a player of interest in a short time is necessary. Therefore, as the wireless communication here, for example, 5G is used.

401 (terminal1), 402 (terminal2), and 403 (terminal3) may be configured by connecting and combining, for example, cameras and smartphones. On the lower right part in FIG. 1, 301 denotes a smartphone that generally controls communication with the server. Application software is installed in the smartphone, and thus various video acquisition services are realized.

300 denotes a (digital) camera that is an image processing apparatus generally used for a professional photographer or a spectator to capture or monitor an image. Here, the camera 300 is connected to the smartphone 301 via a USB or Bluetooth (registered trademark). 320 denotes an antenna used for the smartphone 301 to perform wireless communication with the base station 112.

If the terminal is a smartphone or the like, exchange of videos and control signals with the server is executed in a wireless manner, but connection for executing communication with the terminal may be performed by adaptively using wireless communication and wired communication. For example, control may be performed such that, if a wireless communication environment is 54 communication is performed in a wireless manner, and if the wireless communication environment is LTE, information having a large amount of data is sent in a wired manner, and a control signal having a small amount of data is sent in a wireless manner. The wireless communication may be switched to the wired communication depending on the congestion degree of a line for the wireless communication.

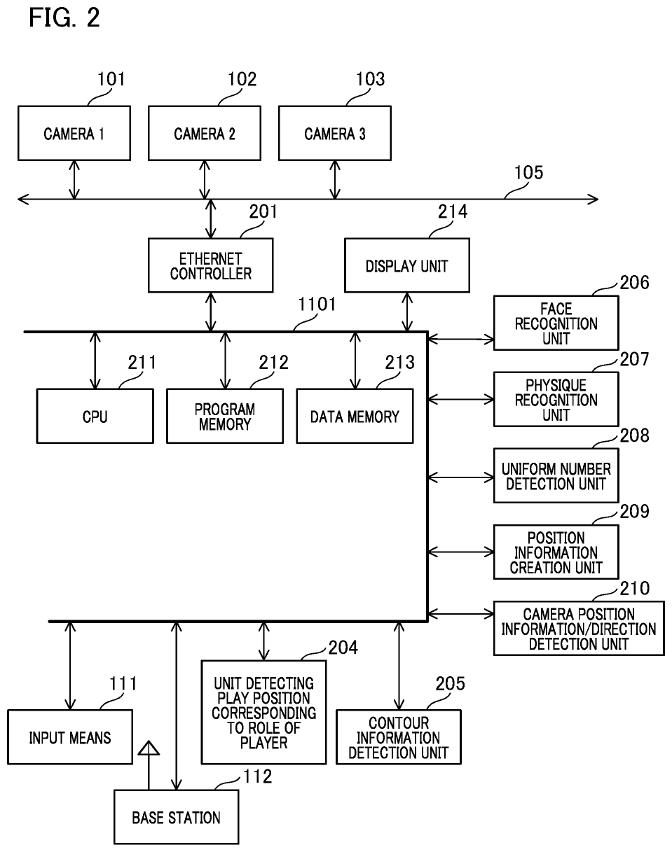

Next, with reference to FIG. 2, a detailed block configuration of the server side will be described. In FIG. 2, reference signs the same as in FIG. 1 indicate the same constituents, and description thereof will not be repeated.

201 denotes an Ethernet (registered trademark) controller, and 204 denotes a detection unit that detects a play position corresponding to a role (so-called position) of a player. Here, a role (position) of a player is set in advance through registration. For example, as roles (positions) in a case of rugby, 1 and 3 are called prop, 2 is called hooker, 4 and 5 are called backs, 6 and 7 are called flanker, 8 is called number 8, 9 is called scrum half, and 10 is called standoff. 11 and 14 are called wing, 12 and 13 are called center, and 15 is called fullback.

As places where players are located, in many cases, the forwards are in front of an attacking scrum and the backs are to the rear of the attacking scrum, such as during set play.

In other words, since positions where players are located are roughly determined according to roles (positions) of the players, it is better to pursue a player of interest after understanding the above role (position) of the player and thus it is possible to pursue the player more effectively and accurately.

Typically, a role of a player is often recognized from a uniform number. However, in some cases, a player with No. 10 may be injured, a player with No. 15 may play a role of standoff (enter the position of No. 10), and a reserve player may take the position of No. 15.

Here, uniform numbers of reserve players are No. 16 to No. 23. However, a position is not fixed only by a uniform number. Therefore, the detection unit indicated by 204 detects a play position corresponding to a preset role of a player, and information regarding the detected play position is received by a CPU 211 of the server 110, but the preset role may be changed due to a player substitution during a competition.

205 denotes a contour information detection unit, and the server 110 notifies each of the terminals 401 to 403 of a position where a player of interest is located, for example, w % ben a professional photographer or a spectator is performing imaging at a magnification of a camera in accordance with a position and an angle thereof while monitoring videos on the terminal. The server 110 notifies each of the terminals 401 to 403 of contour information of the player of interest who is being imaged, and thus each of the terminals 401 to 403 can more reliably recognize the player of interest. The contour information detected by the block indicated by 205 is received by the CPU 211.

206 denotes a player's face recognition unit that finds a player from a video by using A1, particularly, an image recognition technique such as deep learning on the basis of face picture information of a player of interest registered in advance. Information regarding a face recognition result detected by the face recognition unit 206 is also received by the CPU 211.

207 denotes a physique recognition unit that finds a player by using the image recognition technique on the basis of physique picture information of a player of interest registered in advance.

208 denotes a uniform number detection unit that finds a player by using the image recognition technique on the basis of a number (uniform number or the like) of a player of interest registered in advance. Needless to say, when a player's number is detected, not only a number on a back side of a bib but also a number written on a front side thereof may be detected. 209 denotes a position information creation unit that recognizes a position, a direction, and an angle of view of each camera on the basis of position information using a GPS or the like of the cameras 101, 102, and 103 or the like, and information regarding orientations and angle of views of the cameras.

Absolute position information on a ground where the player is located is acquired according to a triangulation method on the basis of a video from each camera. The position information creation unit 209 may also acquire in advance a position on a screen of, for example, a pole as a reference index for detecting a reference position installed in advance in a stadium or a line (for example, a side line or an end line) of a competition field on the basis of the video. An absolute position of the player of interest in the stadium with respect to the field may be acquired with the acquired position as reference coordinates.

210 denotes a camera position information/direction detection unit that detects a position of each terminal and a direction in which a camera is facing and an angle of view of the camera in the terminal on the basis of position information, direction information, and an angle-of-view information of each terminal sent from each of the terminals 401 to 403.

211 denotes a central processing unit (CPU) as a computer that is a central calculation processing device executing control described in the following Embodiment on the basis of a computer program for control stored in a program memory 212 as a storage medium. The CPU 211 is also used as display control unit and controls information to be displayed on a display unit 214 that will be described later. 213 denotes a data memory storing various data referred to by the CPU 211.

The data memory 213 stores past game information, past player information, information regarding today's game (competition), information such as weather, information regarding the number of spectators, information regarding a player of interest, and the current status of a player. The information regarding the player of interest also includes information regarding a face, a uniform number, and a physique.

1101 denotes a data bus line in the server 110.

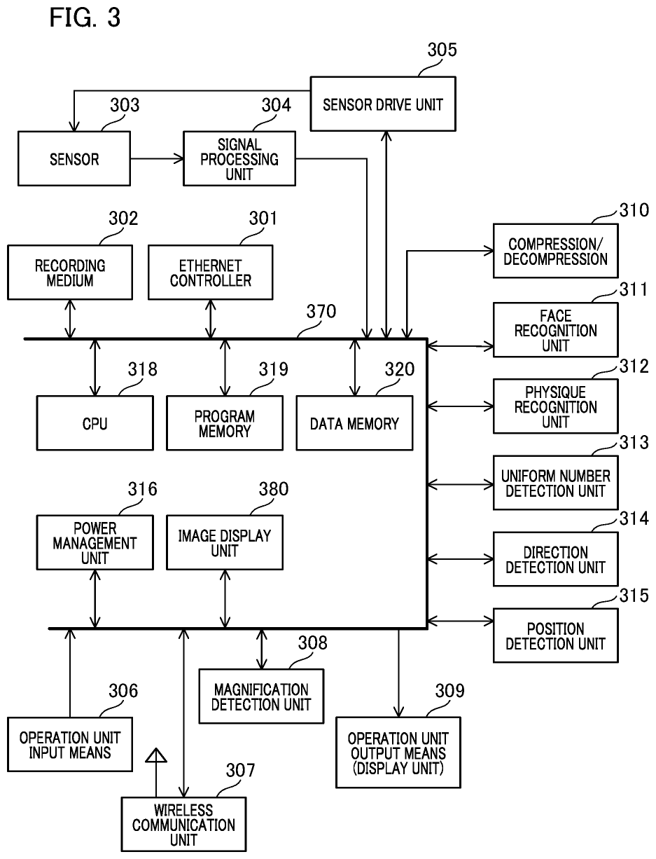

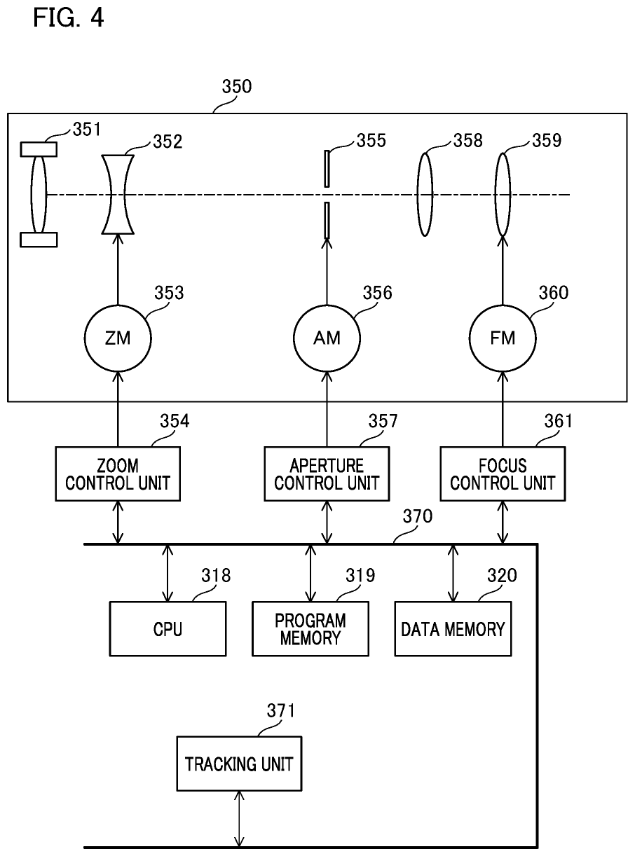

Next, details of the terminal side as an image processing apparatus will be described with reference to FIGS. 3 and 4. FIGS. 3 and 4 are block diagrams illustrating a configuration example of the terminal, and the overall configuration of a (digital) camera 500 as an example of the terminal is illustrated by using two drawings.

The digital camera illustrated in FIGS. 3 and 4 can capture moving images and still images, and can record imaging information. In FIGS. 3 and 4, a central processing unit (CPU) 318, a program memory 319, and a data memory 320 are repeatedly illustrated, but each of the constituents is the same block, and the number of each built constituent is one.

In FIG. 3, 301 denotes an Ethernet (registered trademark) controller. 302 denotes a storage medium that stores moving images and still images captured by the digital camera in a predetermined format.

303 denotes an image sensor as an imaging element such as a CCD or a CMOS, which converts an optical image from an optical signal into an electrical signal and converts the information from analog information into digital data that is then output. 304 denotes a signal processing unit that performs various corrections such as white balance correction or gamma correction on the digital data output from the image sensor 303 and outputs the digital data. 305 denotes a sensor drive unit that controls horizontal/vertical line driving for reading information from the image sensor 303, a timing at which the image sensor 303 outputs the digital data, or the like.

306 denotes operation unit input means. Input is performed in response to a trigger operation for selecting or setting various conditions when imaging is performed by the digital camera, or performing imaging, a selection operation for using a flash, an operation for replacing a battery, and the like. The operation unit input means 306 may select/set whether or not to perform automatic focusing (AF) of the player of interest on the basis of the position information from the server. Selection/setting information regarding whether or not to perform automatic focusing (AF) of the player of interest is output from the operation unit input means 306 to a bus line 370.

The operation unit input means 306 may select/set whether or not to perform automatic tracking of the player of interest on the basis of the position information from the server. Information regarding which player is designated as a player of interest (specific target) or whether or not to perform automatic tracking of the player of interest on the basis of the position information from the server is generated by the operation unit input means 306 as selection unit. In other words, the operation unit input means 306 functions as designation information generation unit for generating designation information regarding a specific target.

307 denotes a wireless communication unit that functions as transmission/reception unit and is used for a camera terminal owned by a professional photographer, a general spectator, or the like to perform communication with the server side in a wireless manner. 308 denotes a magnification detection unit that detects an imaging magnification of the digital camera. 309 denotes operation unit output means that displays UI information such as a menu or setting information on an image display unit 380 that displays image information captured by the digital camera or the like.

310 denotes a compression/decompression circuit. The digital data (RAW data) from the image sensor 303 is subjected to a development process by the signal processing unit 304 and is then compressed by the compression/decompression circuit 310 to be generated as a JPEG image file or an HEIF image file, or the RAW data is compressed without any processing and is generated as a RAW image file. On the other hand, if the RAW image file is subjected to a development process in the camera to be generated as a JPEG image file or an HEIF image file, a process in which compressed information is decompressed and returned to RAW data is performed.

311 denotes a face recognition unit that finds a player of interest through image recognition using AT, particularly, a technique such as deep learning from a video by referring to face picture information registered in the server in advance with respect to the player of interest. Information regarding a face recognition result detected by the face recognition unit 311 is received by the CPU 318 via the bus line 370.

312 denotes a physique recognition unit that finds a player of interest through the above-described image recognition technique from a video by referring to physique picture information registered in the server in advance with respect to the player of interest.

313 denotes a player's uniform number detection unit that finds a player of interest by using the above-described image recognition technique on the basis of a uniform number (a number on the front side may be used) of the player. 314 denotes a direction detection unit that detects a direction in which a lens of the terminal is facing. 315 denotes a position detection unit that detects position information of the terminal by using, for example, a GPS.

316 denotes a power management unit that detects a state of power of the terminal and supplies power to the entire terminal when pressing of a power button is detected in a state in which a power switch is in an OFF state. 318 denotes a CPU as a computer that executes control described in the following Embodiment on the basis of a computer program for control stored in the program memory 319 as a storage medium.

The CPU 318 is also used as display control unit and controls image information to be displayed on a display unit 380. The image display unit 380 is a display unit utilizing a liquid crystal, organic EL, or the like.

The data memory 320 stores setting conditions for the digital camera, or stores captured still images and moving images, and attribute information of the still images and moving images.

In FIG. 4, 350 denotes an imaging lens unit that has a first fixed group lens 351, a zoom lens 352, an aperture 355, a third fixed group lens 358, a focus lens 359, a zoom motor 353, an aperture motor 356, and a focus motor 360. The first fixed group lens 351, the zoom lens 352, the aperture 355, the third fixed group lens 358, and the focus lens 359 configure an imaging optical system. For convenience, each of the lenses 351, 352, 358, and 359 is illustrated as a single lens, but may be configured with a plurality of lenses. The imaging lens unit 350 may be configured as a replacement lens unit that is detachably attached to the digital camera.

A zoom control unit 354 controls an operation of the zoom motor 353 to change a focal length (angle of view) of the imaging lens unit 350. An aperture control unit 357 controls an operation of the aperture motor 356 to change an opening diameter of the aperture 355.

A focus control unit 361 calculates a defocus amount and a defocus direction of the imaging lens unit 350 on the basis of a phase difference between a pair of focus detection signals (an A image and a B image) obtained from the image sensor 303. The focus control unit 361 converts the defocus amount and the defocus direction into a drive amount and a drive direction of the focus motor 360. The focus control unit 361 controls an operation of the focus motor 360 on the basis of the drive amount and the drive direction to drive the focus lens 359, and thus controls a focus (focus adjustment) of the imaging lens unit 350.

As described above, the focus control unit 361 performs automatic focusing (AF) of the phase difference detection type. The focus control unit 361 may execute AF of the contrast detection type of searching for a contrast peak of an image signal obtained from the image sensor 303.

371 denotes a tracking unit that tracks a player of interest in the digital camera. The tracking referred to here is, for example, moving frame display surrounding a player of interest on the screen, focusing on the player of interest tracked by the frame, and adjusting the exposure.

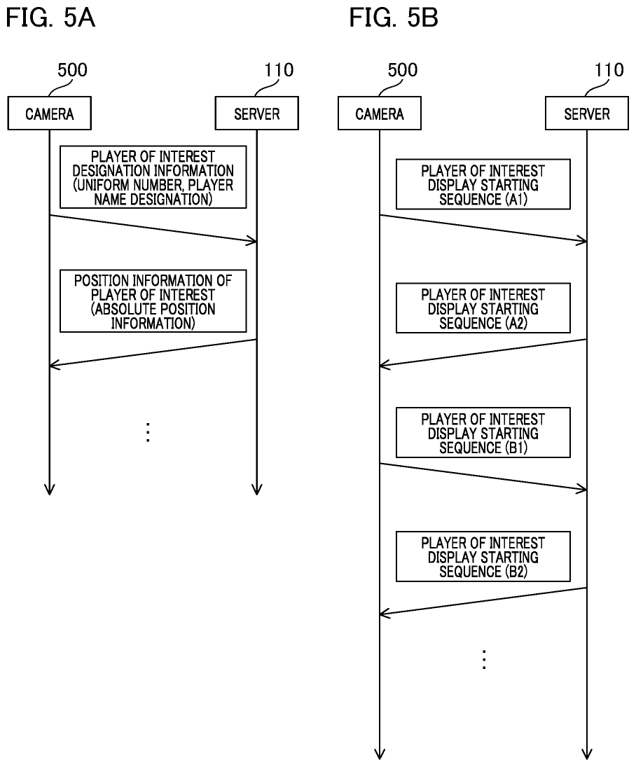

Next, with reference to FIG. 5, an example of a player of interest display starting sequence will be described. The sequence is performed by the server 110 and the camera 500. FIG. 5A illustrates a sequence in which the server 110 side answers a question (request) from the camera 500 side. The server 110 side provides information regarding an absolute position of a player of interest to the camera 500 side.

The camera 500 notifies the server 110 of player of interest designation information (ID information such as a uniform number or a player name). In this case, a user may touch a position of the player of interest on a screen of the terminal, and may surround the periphery of the player of interest with the fingers in a state of touching the screen with the fingers.

Alternatively, a list of a plurality of players may be displayed by a menu on the screen and a player of interest out of the players may be touched, or a text input screen may be displayed on the screen and a player name or a player's uniform number may be entered. In this case, when a face position of the player of interest is touched on the screen, the face or the uniform number may be subjected to image recognition, and then the player name or the uniform number may be sent.

Alternatively, a face image may be sent to the server without image recognition, and the server side may perform image recognition. In this case, if there is a predefined password, the password is also sent to the server. In the server side, the block that supports video capturing sends information regarding an absolute value position where a player is located on the basis of the player of interest designation information (ID information such as a uniform number or a player name). When a password is also sent from the camera, details of information to be sent to the camera are changed according thereto.

In FIG. 5A, the camera also sends information such as position information of the camera that is used by a professional photographer or a spectator and is performing imaging, a direction of the camera, and a magnification of the camera to the server. The server side creates a free-viewpoint video at a position and in a direction where the camera is looking, and recognizes a video actually seen by the camera on the basis of the magnification of the camera. Position information indicating a position of a player in the video actually seen by the camera, contour information of the player, and the like are sent to the camera. The camera displays the player of interest more accurately and conspicuously on the screen of the display unit of the camera, and performs AF and AE on the player of interest, on the basis of the position information, the contour information, and the like sent from the server.

The example of the player of interest display starting sequence of finding a player of interest has been briefly described, but there are many cases of wanting to continue pursuing the player. Therefore, next, a sequence for continuing tracking of the player of interest will be described with reference to FIG. 5 (B). In FIG. 5B, the camera 500 as a terminal makes inquiries (requests) to the server 110 many times, for example, periodically, and continuously recognizes a position of the player. In FIG. 5B, the player of interest display starting sequence (A1, B1, . . . ) is periodically sent from the camera to the server, and the player of interest display starting sequence (A2, B2, . . . ) is periodically sent from the server. An operation of recognizing the position of the player of interest is repeated many times.

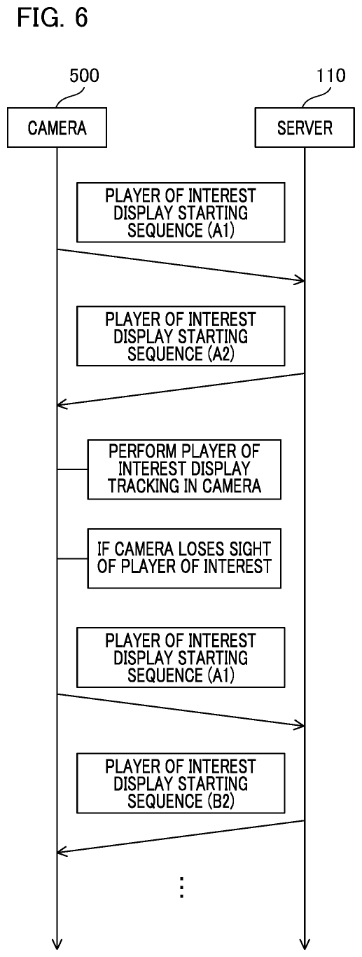

FIG. 6 illustrates a method in which the camera automatically tracks a player of interest. The camera 500 sends ID information of the player of interest to the server 110, and temporarily acquires position information of the player of interest from the server. The camera 500 narrows down a position of the player of interest by referring to the acquired position information, and then continuously tracks the player of interest through image recognition. In the player of interest display tracking sequence in FIG. 6, the camera 500 tracks the player of interest by using the image recognition technique, but, when the player of interest is lost sight of in the middle (when the tracking fails), the camera side requests position information of the player of interest to the server again.

Specifically, when the camera loses sight of the player of interest, the camera sends the player of interest display starting sequence (A1) to the server again, and receives the player of interest display starting sequence (B2) from the server to display a position the player of interest on the screen. Thereafter, the camera tracks the player of interest through image recognition again.

In the present Embodiment, an example of the service for assisting a professional photographer or a spectator in imaging is described, but the service may be used for remote camera control. Such information may be sent from the server, and thus a remote camera mounted on an automatic pan-tilt head may track a player and image a decisive moment.

Although the present Embodiment is described by using an example of imaging assistance, the terminal may be a home-use TV. When a spectator watching the TV designates a player of interest, the server may send position information of the player of interest to the TV and conspicuously display the player of interest by displaying a frame or the like. In addition to the frame, the player of interest may be indicated by a cursor (for example, an arrow), or a color or brightness of a region of the player of interest position may be different from that of other parts. If the player of interest is outside a screen of the terminal, a direction in which the player is deviated from the screen of the terminal may be displayed by an arrow or characters.

If the player of interest is outside the display screen of the terminal, how far the terminal is from the current viewing angle (how much the terminal is deviated) or how much the terminal is to be rotated before the player of interest can enter the display screen may be displayed by using a length or a thickness of an arrow, a number, a scale, or the like.

If the player of interest is inside the screen, a user may perform control to display additional information on the screen, and, if the player of interest moves off the screen, the user may select not to display that the player is off the screen with an arrow or the like.

Alternatively, a competition status may be automatically determined, and, if the player of interest goes down to the bench, even though the player of interest moves off the screen, the fact that the player is off the screen may not be displayed with an arrow or the like. If a user can select the mode in which the display of the additional information is automatically turned off and the mode in which the additional information is not turned off, the usability is further improved.

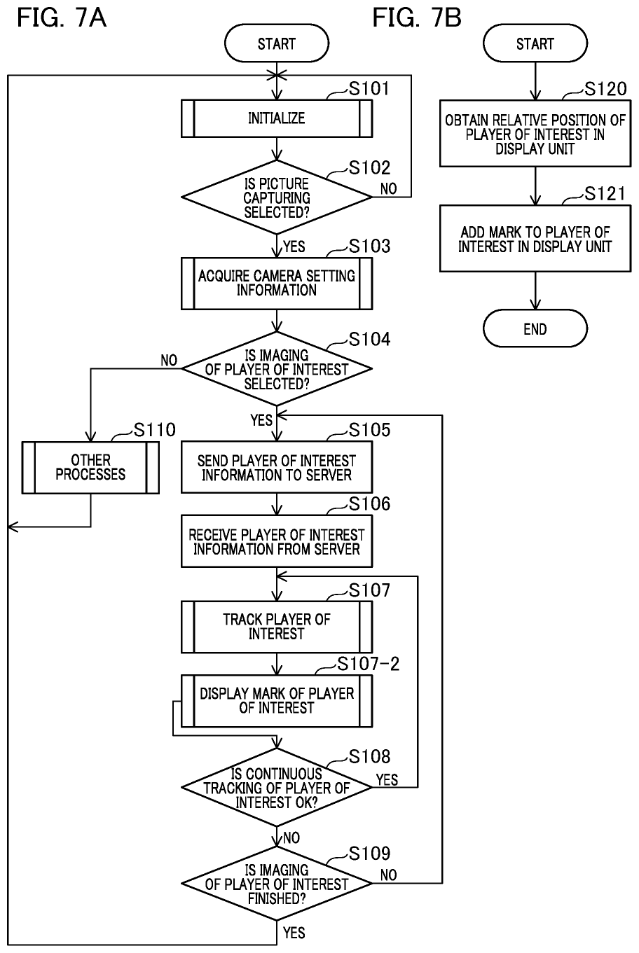

An example of the control sequence in the camera side in FIG. 6 will be described with reference to FIGS. 7(A) and 7(B). FIG. 7A illustrates a player of interest display tracking control flow in the camera side.

In FIG. 7A, S101 denotes initialization. It is determined whether or not picture capturing is selected in S102. If picture capturing is selected, the flow proceeds to S103, and, if picture capturing is not selected, the flow proceeds to S101. In S103, camera setting information is acquired. In S104, it is determined whether or not imaging (designation) of a player of interest is selected, and, when imaging of a player of interest is selected, the flow proceeds to S105.

When imaging of a player of interest is not selected, the flow proceeds to S110 and other processes are performed. In S105, if there are player of interest information (for example, ID information of the player of interest) and a password, the information and the password are sent to the server from the camera. Consequently, the server side detects position information of the player of interest and transmits the position information to the camera. In S106, the position information of the player of interest or the like is received from the server.

In S107, the camera tracks the player of interest while referring to the position information sent from the server. Herein, the camera performs, for example, image recognition of the player of interest, and tracks the player of interest. In this case, the player is tracked on the basis of a recognition result of any of a uniform number of the player, face information of the player, and a physique of the player or a combination thereof. That is, a shape of a part or the whole of the player of interest is subjected to image recognition, and thus the player of interest is tracked. However, since the player of interest may be lost sight of, if the users imaging position is bad, a field of view of the camera is narrow, or the player of interest is hidden behind other subjects depending on an imaging angle, and if the player of interest is lost sight of, a request for position information is sent to the server again.

In S107-2, an example of mark display as additional information for the player of interest is illustrated. In other words, as the additional information, a cursor indicating the player of interest is displayed, a frame is displayed at the position of the player of interest, a color or brightness of the player of interest position is changed to be conspicuous, or a combination thereof is displayed. In addition to the mark, characters may be displayed. In a state in which a live view image from the image sensor is displayed on the image display unit, additional information indicating the position is superimposed on the player of interest.

FIG. 7B illustrates an example of a flow related to S107-2 of displaying a mark, which will be described later in detail. The tracking operation in S107 as described above may be made selectable by a user with the selection switch so as to be skipped and not to be executed. Alternatively, a mode may be provided in which the tracking operation is executed when a player of interest is inside a screen but the tracking operation is not executed if the player of interest moves off the screen, and the mode may be selected.

A competition status may be automatically determined, and, for example, if a player of interest enters the bench, the tracking operation (displaying additional information such as an arrow) for the player of interest outside the screen may be controlled to be automatically stopped. Alternatively, regardless of whether the player of interest is inside or outside the screen, when the server knows that the player of interest has entered the bench, display of the player of interest position on the screen, automatic focusing for the player of interest, and automatic exposure adjustment for the player of interest may be controlled to be stopped.

In S108, it is determined whether or not continuous tracking of the player of interest is OK (successful), and, if continuous tracking of the player of interest is successful, the flow proceeds to S107 and the camera continuously tracks the player of interest. If continuous tracking of the player of interest is not successful, the flow proceeds to S109.

In S109, it is determined whether or not imaging of the player of interest is finished, and, if imaging of the player of interest is finished, the flow proceeds to S101.

If imaging of the player of interest is continued, the flow proceeds to S105, the information regarding the player of interest is sent to the server again, the information regarding the player of interest is received from the server in S106, and a position of the player of interest is recognized again, and imaging the player of interest is continued. That is, if the tracking fails, a determination result is No in S108, and, in this case, if the tracking is continued, the flow returns to S105, and a request for position information is sent to the server.

FIG. 7B illustrates an example of a flow of the player of interest mark display in S107-2 in the camera side. In S120, a relative position of the player of interest in the display unit is calculated and obtained on the basis of the position information received from the server. In S121, in a state where the live view image from the image sensor is displayed on the image display unit, a mark or the like indicating the position is superimposed on the player of interest.

In the above Embodiment, for example, the server 110 reads a video of the entire competition field and acquires coordinates, and can thus ascertain a position of capturing the competition field from a video captured by a professional photographer or a spectator. That is, the server ascertains a video of the entire competition field in advance from a plurality of cameras (stationary cameras or mobile cameras) for the server. Consequently, it is possible to map an absolute position information of the player of interest in the field to a video seen by a professional photographer or a spectator on the terminal or the digital camera.

When a terminal such as a camera of a professional photographer or a spectator receives the absolute position information of the player from the server, the absolute position information can be mapped to a video currently being captured or monitored. For example, the absolute position information in the field of the player of interest from the server is indicated by (X, Y). It is necessary to convert the absolute position information into relative position information (X′, Y′) when viewed from the camera according to position information of each camera. The above conversion from the absolute position information to the relative position information may be performed in the camera side as in S120, or the relative position information may be sent to each terminal (camera or the like) after conversion in the server side.

If the above conversion is executed in a terminal such as a camera, the absolute position information (X, Y) sent from the server is converted into the relative position information (X′, Y′) according to position information using a GPS or the like of each camera. The relative position information is used as position information in the display screen of the camera side.

On the other hand, if the server executes the above conversion, the server converts the absolute position information (X, Y) sent from the server into the relative position information (X′, Y′) according to position information using a GPS or the like of each camera. The server sends the relative position information to each camera, and the camera that receives the relative position information uses the relative position information as position information in the display screen of the camera side.

As described above, a terminal such as a camera of a professional photographer or a spectator is less likely to lose sight of a player of interest, and thus it is possible to take a good picture of the player of interest without missing the timing.

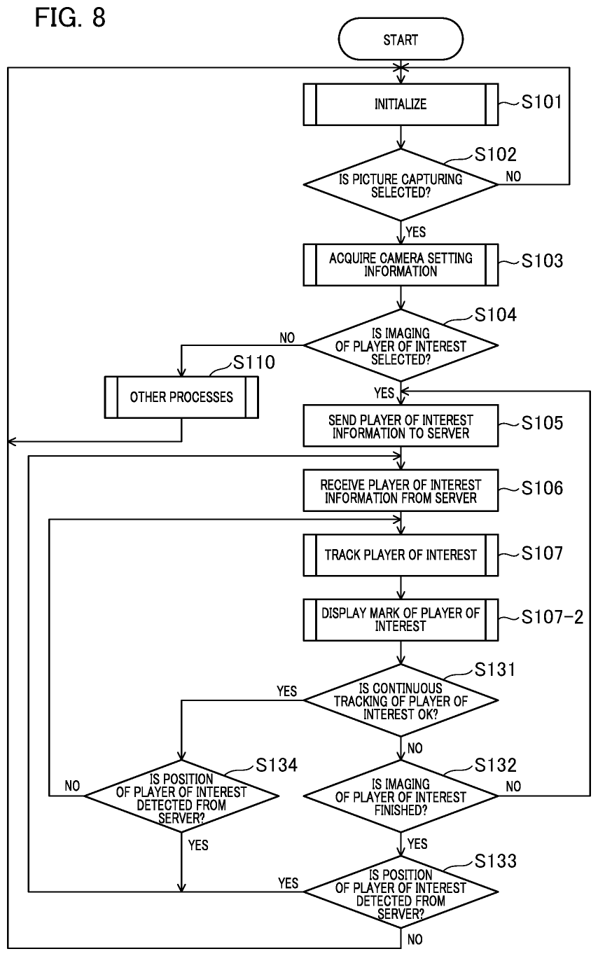

FIG. 8 illustrates another example of a flow of the player of interest display tracking control in a terminal side such as a camera. In FIG. 8, control in S101, S102, S103, S104, S105, S106, S107, S107-2, and S110 is the same as that in FIG. 7, and the description thereof will not be repeated.

In S131 in FIG. 8, it is determined whether or not continuous tracking of the player of interest is OK (successful), and, if continuous tracking of the player of interest is successful, the flow proceeds to S134. If continuous tracking of the player of interest is not successful, the flow proceeds to S132. In S132, it is determined whether or not imaging of the player of interest is finished, and, if imaging of the player of interest is finished, the flow proceeds to S133. If imaging of the player of interest is continued, the flow proceeds to S105, the information regarding the player of interest is sent to the server again, the information regarding the player of interest is received from the server in S106, and a position of the player of interest is recognized again, and imaging the player of interest is continued.

In S133, it is determined whether or not a position of the player of interest from the server is detected, and, if the position of the player of interest from the server is detected, the flow proceeds to S106, and, if the position of the player of interest from the server is not detected, the flow proceeds to S101. In S134, it is determined whether or not a position of the player of interest from the server is detected, and, if the position of the player of interest from the server is detected, the flow proceeds to S106, and, if the position of the player of interest from the server is not detected, the flow proceeds to S107.

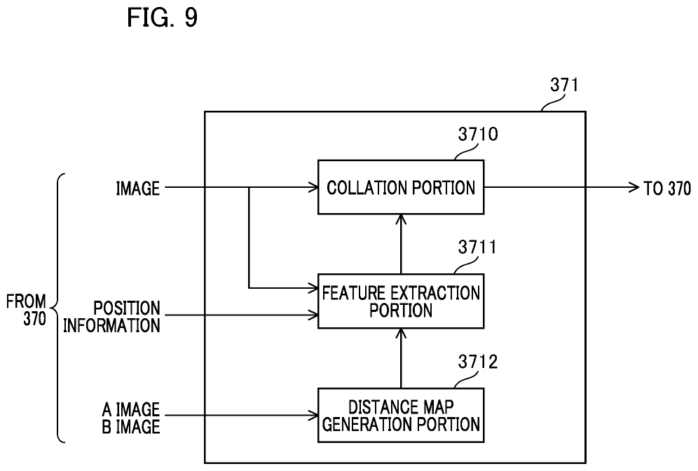

Next, the tracking unit 371 of the digital camera will be described with reference to FIG. 9.

FIG. 9 is a block diagram illustrating a functional configuration example of the tracking unit 371 of the digital camera. The tracking unit 371 includes a collation portion 3710, a feature extraction portion 3711, and a distance map generation portion 3712. The feature extraction portion 3711 specifies an image region (subject region) to be tracked on the basis of position information sent from the server. Feature data is extracted from the image of the subject region.

On the other hand, the collation portion 3710 searches captured images of continuously supplied frames for a region having a high degree of similarity to the subject region of the previous frame as the subject region with reference to the extracted feature data. The distance map generation portion 3712 may acquire distance information to a subject from a pair of parallax images (A image and B image) from the image sensor, and improve the accuracy of specifying the subject region in the collation portion 3710. However, the distance map generation portion 3712 may be omitted.

When the collation portion 3710 searches for a region having a high degree of similarity to the subject region as the subject region on the basis of the feature data of the subject region in the image supplied from the feature extraction portion 3711, for example, template matching or histogram matching is used.

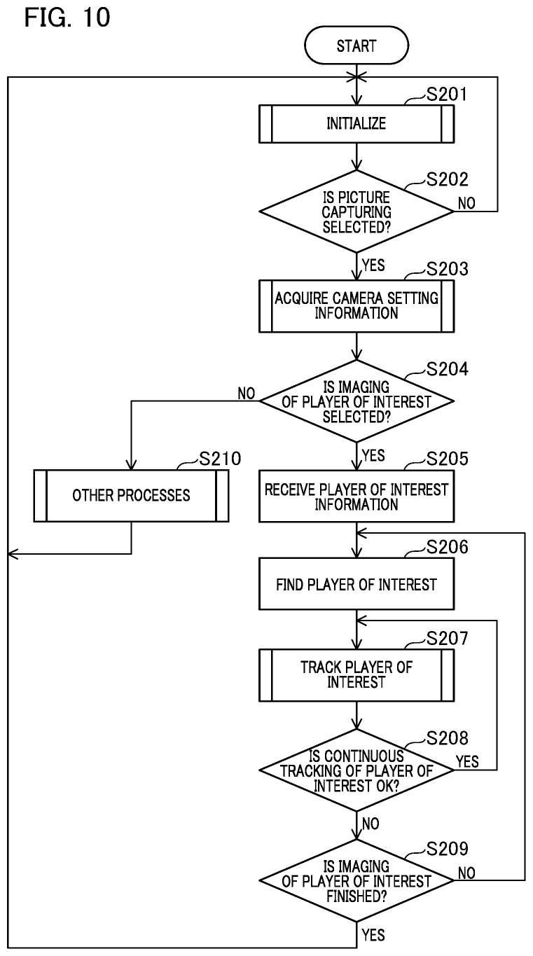

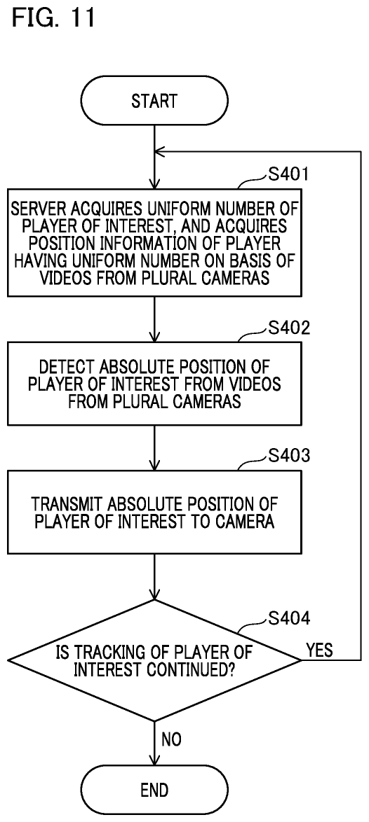

Next, a player of interest detection control flow in the server side will be described with reference to FIGS. 10 and 11.

The server recognizes an image of the player of interest on the basis of the ID information of the player of interest sent from a terminal such as a camera. The server detects position information of the player on the basis of videos from a plurality of cameras (stationary cameras, mobile cameras, or the like) for the server and sends the position information of the player to a camera terminal or the like of a professional photographer or a spectator. Particularly, when a professional photographer or a spectator performs imaging, if there is position information of the player of interest from the server, the player of interest can be reliably imaged without making a mistake. The information from the server is also important when the player is lost sight of due to a blind spot while tracking the player of interest with the camera. In the server side, the position information of the player is continuously detected on the basis of videos from the plurality of cameras for the server.

FIG. 10 illustrates a main flow of player of interest detection control in the server side.

In FIG. 10, first, initialization is performed in S201. Next, in S202, it is determined whether or not picture capturing is selected in the camera, and when picture capturing is selected, the flow proceeds to S203 and camera setting information is acquired. In this case, if there is a password in the camera setting information, the password is also acquired. If picture capturing is not selected, the flow proceeds to S201. In S204, it is determined whether or not imaging (designation) of the player of interest is selected, and, if imaging of the player of interest is selected, the flow proceeds to S205, and the server receives ID information (for example, a player name or a uniform number) of the player of interest from the camera. If imaging of the player of interest is not selected in S204, the flow proceeds to S210 and other processes are performed.

In S206, the server finds the player of interest on the screen through image recognition based on videos from the plurality of cameras (stationary cameras, mobile cameras, or the like) on the basis of the ID information of the player of interest. In S207, the server tracks the player of interest on the basis of images from the plurality of cameras. In S208, it is determined whether or not continuous tracking of the player of interest is OK (successful), and, if continuous tracking of the player of interest is successful, the flow returns to S207, and the player of interest is continuously tracked on the basis of the information from the plurality of cameras. If continuous tracking of the player of interest is not successful in S208, the flow proceeds to S209.

In S209, it is determined whether or not imaging of the player of interest is finished, and, if imaging of the player of interest is finished, the flow returns to S201. If imaging of the player of interest is continued in S209, the flow returns to S206. The server searches for information from the plurality of cameras (stationary cameras or mobile cameras) for the server on the basis of the ID information of the player of interest again, finds the player of interest, and continuously tracks the player of interest on the basis of videos from the plurality of cameras in S207.

Next, an example of a method for finding a player of interest in S206 and tracking the player of interest in S207 will be described with reference to FIG. 11.

FIG. 11 illustrates a player of interest detection control flow using uniform number information. In FIG. 11, in S401, the server acquires a uniform number from the data memory 213 on the basis of the ID information of the player of interest, searches for the uniform number from video information of the plurality of cameras for the server through image recognition, and acquires position information of the player having the uniform number.

In S402, absolute position information of the player of interest is acquired by further integrating the position information acquired from the images from the plurality of cameras for the server. The information from the plurality of cameras for the server is integrated in this way, and thus the accuracy of absolute position information of a player having a certain uniform number is improved. In S403, the absolute position of the player of interest detected in S402 is transmitted to a terminal such as a camera owned by a professional photographer or a spectator. In S404, it is determined whether or not the tracking of the player of interest is continued, and, if the tracking of the player of interest is continued, the flow returns to S401. If the tracking of the player of interest is not continued, the flow in FIG. 11 is finished.

A video from at least one camera among the plurality of cameras for the server may be used to find the uniform number of the player of interest, and the position information of the player of interest may be acquired by entering information such as a size and an angle of the viewed uniform number, and the background (competition field). The videos from the plurality of cameras for the server may be used to find the uniform number of the player of interest in the same way, and the accuracy of the position information of the player of interest can be increased by entering information such as a size and an angle of the viewed uniform number, and the background (field).

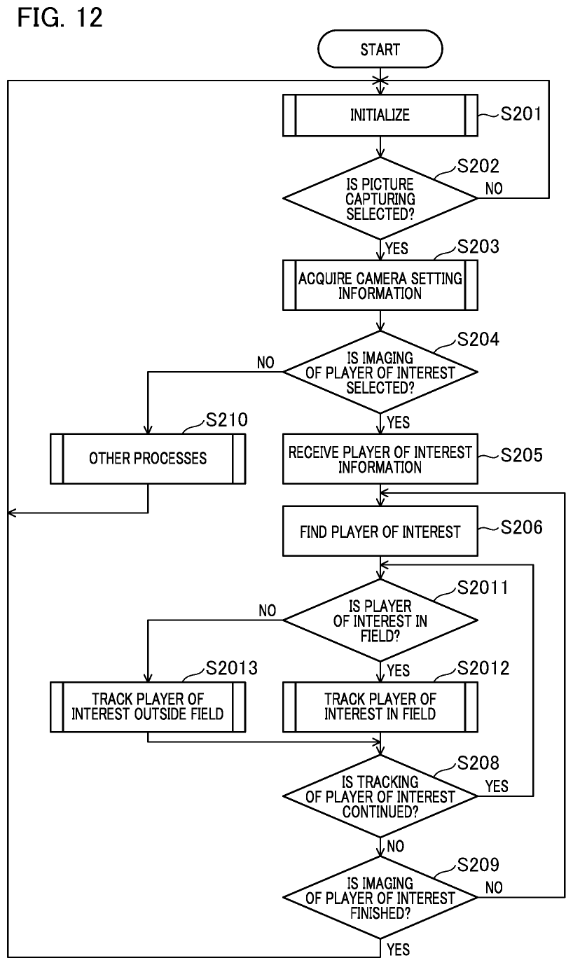

Next, FIG. 12 is a diagram illustrating another example of the player of interest detection control flow in the server side, and illustrates an example of tracking control for a player of interest outside the field such as a locker room, for example, which cannot be seen by a spectator. Since a step having the same reference sign as in FIG. 10 indicates the same step, the description thereof will not be repeated.

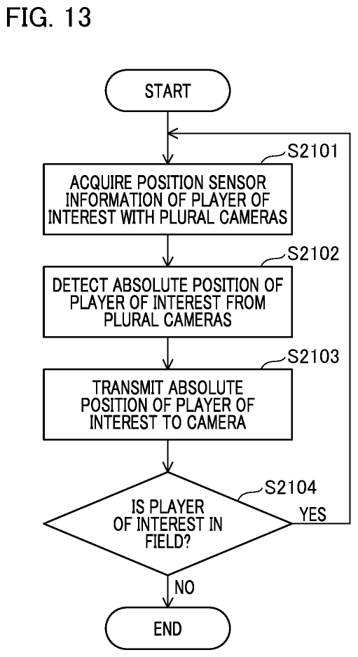

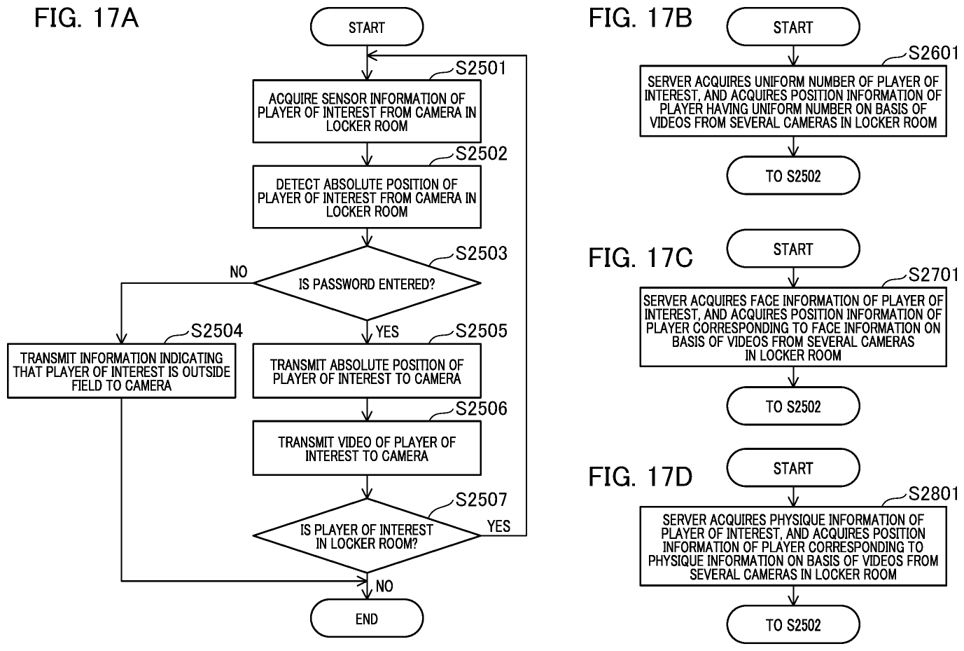

In FIG. 12, in S2011, it is determined whether or not a player of interest is in the field, and, if the player of interest is in the field, the flow proceeds to S2012. If the player of interest is not in the field, the flow proceeds to S2013. S2012 denotes tracking of the player of interest in the field. An example of tracking control for a player of interest in the field will be described with reference to FIG. 13 to FIG. 16. An example of tracking control for a player of interest outside the field in S2013 in FIG. 12 will be described with reference to FIG. 17A to FIG. 17D.

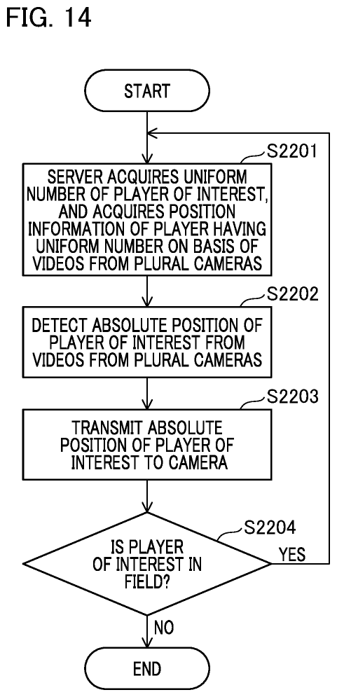

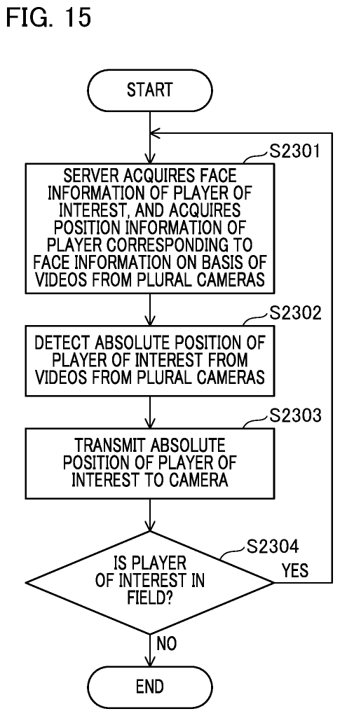

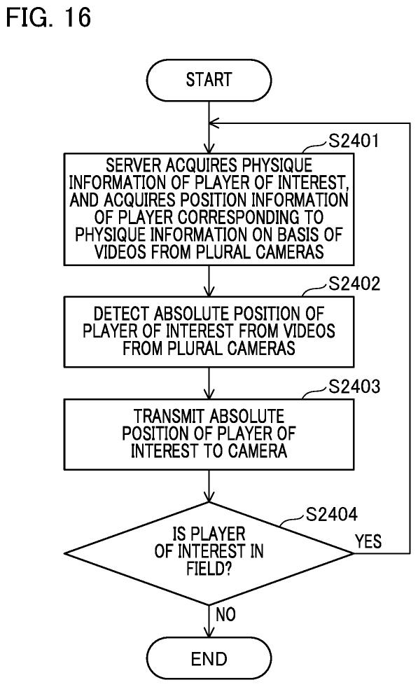

Tracking of the player of interest in the field in S2012 and tracking of the player of interest outside the field in S2013 are controlled according to a pair of FIG. 13 and FIG. 17A, a pair of FIG. 14 and FIG. 17B, a pair of FIG. 15 and FIG. 17C, and a pair of FIG. 16 and FIG. 17D.

First, FIG. 13 illustrates a detection control flow for a player of interest in the field in S2012 using position sensor information in the server side, and FIG. 17A illustrates a detection control flow for a player of interest outside the field in S2013 using position sensor information in the server side.

In this example, it is assumed that a player has a position sensor built into clothing such as a uniform, or the player wears a position sensor on arms, waist, legs, or the like thereof by using a belt or the like. Information from this position sensor is transmitted by communication unit, and thus the server recognizes a signal from the player's position sensor, and generates position information. The server notifies a terminal such as a camera owned by a professional photographer or a spectator of the position information.

Here, since the information in the field can be seen by a general spectator without a password, when a player is in the field, position information of the player may be sent even if the password is not set. However, if the password is not set, a location or a video outside the field, for example, position information indicating that the player is in a locker room and a video in the locker room are not sent. If no password is set, it is assumed that a player of interest will only notify the camera that the player of interest is outside the field.

The password is acquired in advance on the basis of a contract or the like, is entered with a terminal such as a camera owned by a professional photographer or a spectator, and is sent from the camera terminal to the server together with designation information for the player of interest. The server changes details transmitted to the camera terminal according to the entry of the password from the camera terminal.

In FIG. 13, in S2101, the server acquires position sensor information of the player of interest from the plurality of cameras for the server. The position sensor information includes a direction of a radio wave from the position sensor and an intensity level of the received radio wave. In S2102, an absolute position of the player of interest is detected on the basis of the position sensor information of the plurality of cameras for the server. In S2103, the absolute position of the player of interest is transmitted to a terminal such as a camera owned by a professional photographer or a spectator. In S2104, it is determined whether or not the player of interest is in the field, and, if the player of interest is in the field, the flow proceeds to S2101. If the player of interest is not in the field, the control in FIG. 13 is finished.

In the case of this example, at least one of the plurality of cameras (stationary cameras or mobile cameras) for the server has a detector that detects information from the position sensor owned by a player in addition to acquiring images and sound. Each camera among the plurality of cameras for the server can receive information from the position sensor of the player and recognize a direction of a received radio wave and the level of the received radio wave. However, in the present Embodiment, the position sensor information of the player can be recognized by each of the plurality of cameras for the server. The position sensor information from the plurality of cameras for the server is integrated, and thus position information of the player is analyzed more accurately.

Next, FIG. 17A is a diagram illustrating a specific detection control flow for a player of interest outside a field using position sensor information in the server side. In FIG. 17A, in S2501, the server acquires the position sensor information of the player of interest with one or several cameras in the locker room. In S2502, an absolute position of the player of interest is detected on the basis of the position sensor information from several cameras in the locker room. In S2503, it is determined whether or not the password has been input from the camera of the professional photographer or the spectator.

If the password has been input from the camera of the professional photographer or the spectator, the flow proceeds to S2505, and, if the password has not been input from the camera of the professional photographer or the spectator, the flow proceeds to S2504. In S2504, the player of interest transmits information indicating that the player of interest is outside the field to the camera. In S2505, an absolute position (for example, being in the locker room) of the player of interest is transmitted to the camera.

In S2506, for example, a blurred or mosaic-filled video in the locker room of the player of interest is transmitted to the camera. Here, an example of sending a video of the player of interest as information other than the position information of the player of interest is described, but profile information or comment information from a commentator may be sent instead of or along with the video. In S2507, it is determined whether or not the player of interest is in the locker room, and, if the player of interest is in the locker room, the flow proceeds to S2501. If the player of interest is not in the locker room, the present control is finished.

Next, FIG. 14 illustrates a detection control flow for a player of interest in a field using uniform number information of the player of interest (including a number on a front side of a bib) in the server side.

FIG. 17B illustrates a detection control flow for a player of interest outside the field using uniform number information in the server side.

The server has a detecting unit for detecting a uniform number of a player on the basis of videos from a plurality of cameras (stationary cameras or mobile cameras) for the server. The server notifies a terminal such as a camera owned by a professional photographer or a spectator of information in which the uniform number is correlated with position information of the player.

In FIG. 14, in S2201, the server acquires the uniform number from the data memory 213 on the basis of the ID information of the player of interest. Position information of the player having the uniform number is acquired through image recognition on the basis of videos from the plurality of cameras (stationary cameras or mobile cameras) for the server. In S2202, an absolute position of the player of interest is detected on the basis of the position information of the player having the uniform number based on the videos from the plurality of cameras, acquired in S2201. In S2203, the absolute position of the player of interest detected in S2202 is transmitted to the terminal such as a camera owned by the professional photographer or the spectator. In S2204, it is determined whether or not the player of interest is in the field, and, if the player of interest is in the field, the flow proceeds to S2201. If the player of interest is not in the field, the control in FIG. 14 is finished.

On the other hand, FIG. 17B is a diagram in which S2501 in FIG. 17A is replaced with S2601. That is, in S2601, the server acquires a uniform number of the player of interest from the data memory 213 on the basis of the ID information of the player of interest, and acquires position information of the player having the uniform number by using videos from several cameras in the locker room. Thereafter, the flow proceeds to S2502.

Next, FIG. 15 illustrates a detection control flow for a player of interest in a field using face recognition information in the server side. FIG. 17 (C) illustrates a detection control flow for a player of interest outside a field using face recognition information in the server side.

The data memory 213 of the server stores a plurality of pieces of face information captured in the past of all players registered as members in a game. The server has a unit for detecting face information of a player on the basis of videos from a plurality of cameras for the server. Then, the server detects a player by comparing the face information detected from the plurality of cameras for the server with the plurality of face images captured in the past of the players registered as members in the game by using, for example, A1.

In FIG. 15, in S2301, the server acquires the face information of the player of interest from the data memory 213 on the basis of the ID information of the player of interest, and uses video information from the plurality of cameras for the server to acquire position information of the player corresponding to the face information. If a player corresponding to the face information of the player of interest is found by using a video from one camera out of the plurality of cameras for the server, the position information of the player of interest may be acquired by entering information such as a size and an angle of the viewed player, and the background (field). Similarly, the player corresponding to the face information of the player of interest may be found with the plurality of cameras for the server and the position information of the player of interest can be acquired more accurately by entering information such as a size and an angle of the viewed player, and the background (field).

In S2302, an absolute position of the player of interest is detected on the basis of the position information of the player of interest acquired in S2301. In S2303, the absolute position of the player of interest detected in S2302 is transmitted to a terminal such as a camera owned by the professional photographer or the spectator. In S2304, it is determined whether or not the player of interest is in the field, and, if the player of interest is in the field, the flow proceeds to S2301. If the player of interest is not in the field, the present control is finished.

FIG. 17C is a diagram in which S2501 in FIG. 17A is replaced with S2701. In S2701, the server acquires face information of the player of interest from the data memory 213 on the basis of the ID information of the player of interest, and acquires position information of a player corresponding to the face information by using videos from several cameras in the locker room. Thereafter, the flow proceeds to S2502.

Next, FIG. 16 illustrates a detection control flow for a player of interest in a field using physique recognition information in the server side. FIG. 17 (D) illustrates a detection control flow for a player of interest outside a field using physique recognition information in the server side.

The data memory 213 of the server stores a plurality of pieces of physique image information taken in the past of players registered as members in a game. In addition, the server has a unit for detecting physique information of a player on the basis of videos from a plurality of cameras for the server. The server detects a player by comparing the physique information detected from the plurality of cameras for the server with the plurality of pieces of physique image information taken in the past of the players registered as members in the game by using, for example, A1.

In FIG. 16, in S2401, the server acquires physique image information from the data memory 213 on the basis of the ID information of the player of interest, and acquires position information of the player having this physique by using the video information from the plurality of cameras for the server. If a player corresponding to the physique image of the player of interest is found by using a video from one camera out of the plurality of cameras for the server, the position information of the player of interest may be acquired by acquiring information such as a size and an angle of the viewed player, and the background (field). Similarly, if the player corresponding to the physique image of the player of interest may be found from videos from the plurality of cameras for the server, the position information of the player of interest can be acquired more accurately by acquiring information such as a size and an angle of the viewed player, and the background (field). In S2402, an absolute position of the player of interest is detected on the basis of the position information of the player corresponding to the physique information acquired in S2401.

In S2403, the absolute position of the player of interest detected in S2402 is transmitted to a terminal such as a camera owned by the professional photographer or the spectator. In S2404, it is determined whether or not the player of interest is in the field, and, if the player of interest is in the field, the flow proceeds to S2401. If the player of interest is not in the field, the present control is finished.

FIG. 17D is a diagram in which S2501 in FIG. 17A is replaced with S2801. In S2801, the server acquires physique image information of the player of interest from the data memory 213 on the basis of the ID information of the player of interest, and inputs position information of a player having this physique by using videos from several cameras in the locker room. Thereafter, the flow proceeds to S2502.

In the above Embodiment, the locker room has been used as an example, but, needless to say, for example, a bench, other waiting room, a training room, a medical office, and a lobby may be used. If there is a player of interest in such a place, for example, in S2506 in FIG. 17A, a blurred image of the player of interest is sent to a terminal such as a camera, but various other information (for example, a profile of the player of interest or comments of a commentator) may be sent instead of sending the image.

In the above description, the server is set in advance according to a password. An example has been described in which, if a password is entered, information that cannot be seen on a camera terminal or the like without entering the password, for example, information indicating that a player of interest is in a waiting room or a locker room is sent to the camera terminal. In this case, an example has been described in which a video of the player of interest in the waiting room or the locker room is blurred or mosaiced and is sent to a terminal such as a camera in which a password has been entered. However, not only the presence or absence of a password, but also a plurality of levels of passwords may be set, and details of information received by the camera terminal or the like may be changed according to a level of an entered password.

In the above description, the control of the server side for a camera terminal in which a password is entered has been described, and, next, control of the camera terminal side will be described.

As a position information notification service, the camera terminal in which a password is entered is notified of a position where a player of interest is located outside a field when the player of interest is not in the field. For example, information such as “*** player is now in the locker room” or “*** player is now moving from the locker room to the field” is sent from the server to a terminal such as a camera, and is displayed on the terminal such as a camera in which a password is entered.

A blurred or mosaiced video of the player of interest in the locker room is displayed on a part of the camera in a picture-in-picture form.

Consequently, a professional photographer or some spectators with passwords can know where a player of interest is even if the player is not in the field, and also see a video of the player. Therefore, the professional photographer or the like is more likely to be able to take a good picture without missing a photographic opportunity.

For example, even if multiple competitions are going on in the field at the same time, such as in the Olympics, where a player of interest who is not in the field is now can be easily known, and thus it is possible to provide differentiated services for taking good pictures in a timely manner.

In addition to the locker room, information such as “the player is moving toward the competition venue by bus” may also be displayed on a camera terminal of a professional photographer who has entered a password, which is a very convenient service.

In the present Embodiment, a notification of a position of a player of interest inside or outside a screen of a terminal such as a camera can be provided by, for example, an arrow or a character in a video viewed by a professional photographer or a spectator, the player of interest is not lost sight of and thus it is difficult to miss a valuable photographic opportunity.

If position information is sent from the server to a plurality of camera terminals by broadcasting, the position information is sent as absolute position information, but a notification of information detected by the server is provided to only a terminal such as a camera owned by a specific photographer or a specific spectator. This information may be sent to individual camera terminals, or may be sent to terminals such as cameras owned by photographers or spectators in a specific area of a stadium. In that case, the server may send relative position information to those camera terminals.

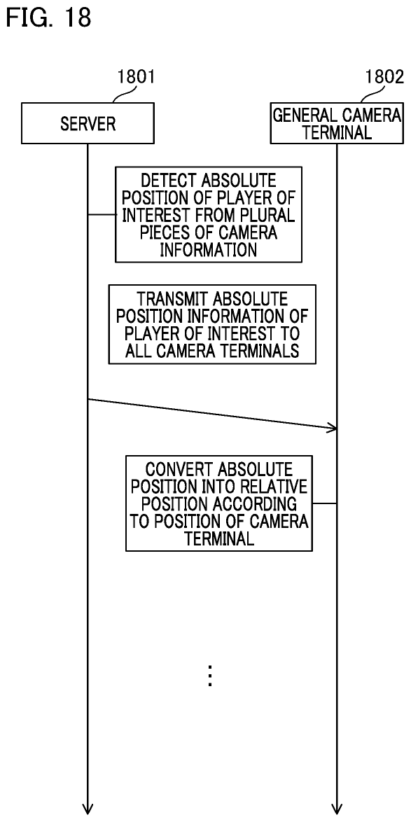

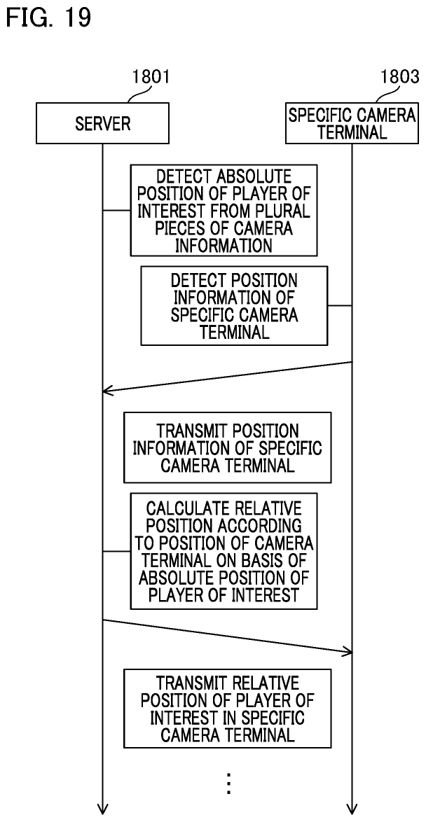

FIGS. 18 and 19 illustrate examples of conversion sequences of absolute position information and relative position information in the field.

If the server sends absolute position information by broadcasting, a terminal such as a camera owned by each professional photographer or each spectator performs conversion from absolute position information into relative position information.

FIG. 18 illustrates a sequence of converting an absolute position in a competition field into a relative position in a terminal side such as a camera. In FIG. 18, a server 1801 detects an absolute position of a player of interest on the basis of information from a plurality of cameras (stationary cameras and mobile cameras) for the server. The server sends absolute position information of the player of interest to, for example, a camera terminal 1802 of a spectator. The camera terminal 1802 of the spectator converts the absolute position information sent from the server into relative position information when viewed on a display unit of the camera terminal according to position information of the terminal such as the camera of the spectator, and displays the position information of the player of interest on the display unit on the basis of this information.

Next, with reference to FIG. 19, an example will be described in which, when the server receives position information of each specific camera terminal, the server side converts absolute position information into relative position information in the server side and then sends the relative position information to each camera terminal.

FIG. 19 illustrates a flow of converting an absolute position into a relative position in the server. In FIG. 19, the server 1801 acquires position information of each player of interest from videos or the like from a plurality of cameras for the server, and detects an absolute position of each player of interest. Each specific camera terminal detects position information of the camera terminal by using GPS or the like, and sends the position information of each camera terminal 1803 from the camera terminal 1803 to the server 1801.

The server 1801 performs computation for conversion into relative position information when viewed at each camera terminal position on the basis of the absolute position information of each player of interest designated from each camera terminal 1803 and the position information of each camera terminal, and sends the relative position information to each camera terminal. Each camera terminal 1803 displays the position of the player of interest on the display unit of each camera terminal on the basis of the relative position information when viewed at the camera terminal received from the server 1801.

There are cases where a position of the camera terminal is fixed and the camera terminal is moved. For example, when watching a game from spectator seats, the position of the camera terminal is almost fixed. Thus, since a video seen from a certain spectator seat is determined, a service for creating relative position information seen from a terminal such as a camera owned by a spectator from absolute position information of a player of interest detected by the server is very valuable.

In order to convert absolute position information into relative position information in the camera terminal side, it is desirable to download software that enables conversion between a video seen from a spectator seat and an absolute position of the field in advance. GPS position information of the camera terminal is acquired or a video from the spectator seat is acquired and matched to create relative position information.

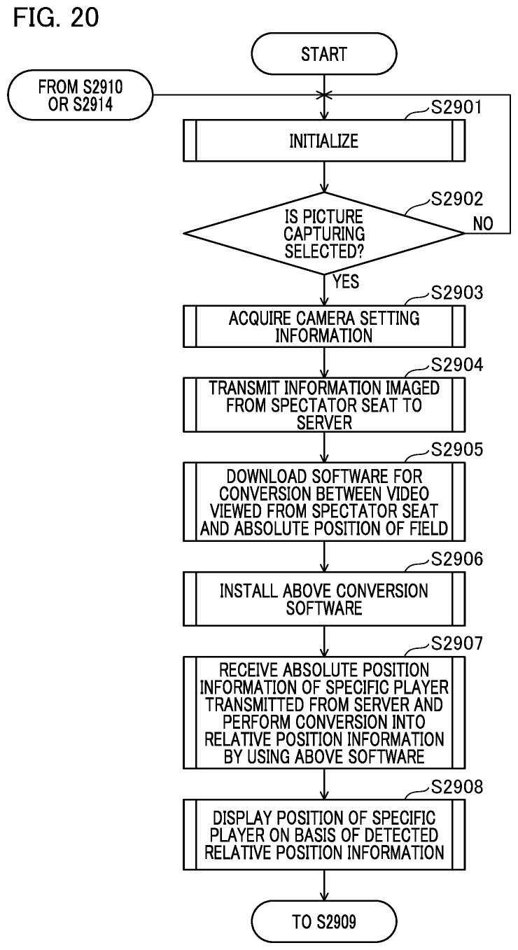

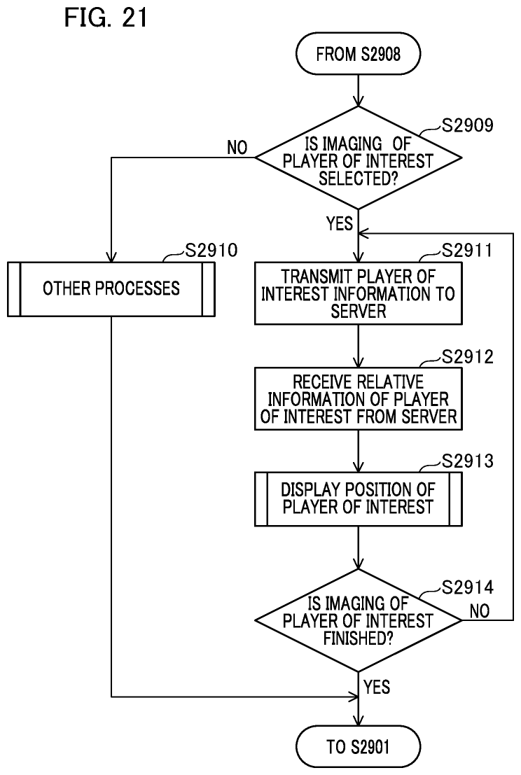

FIGS. 20 and 21 illustrate an example of a flow for displaying and tracking a player of interest by converting absolute position information into relative position information in the camera terminal side.

In FIG. 20, S2901 denotes initialization. It is determined whether or not picture capturing is selected in S2902. If picture capturing is selected, the flow proceeds to S2903, and, if picture capturing is not selected, the flow proceeds to S2901. In S2903, camera setting information is acquired. In S2904, information imaged from the spectator seats is sent to the server. The server optimizes the conversion software on the basis of the information. In S2905, the above software for conversion between a video viewed from the spectator seat and an absolute position of the field is downloaded from the server. In S2906, the software downloaded in S2905 is installed in the camera terminal.

In S2907, default absolute position information of a specific player sent from the server is received and is converted into relative position information by the software. In S2908, a mark such as a frame or an arrow is displayed at the position of the specific player on the basis of the detected relative position information. At this time, a live view image from the image sensor is displayed on the image display unit, and the above mark is superimposed and displayed on the live view image.

Next, in S2909 in FIG. 21, it is determined whether or not imaging of the player of interest designated by the camera terminal is selected. If imaging of the player of interest is selected, the flow proceeds to S2911, and, if imaging of the player of interest is not selected, the flow proceeds to S2910, other processes are performed, and then the flow proceeds to S2901. In S2911, information regarding the player of interest is sent from the camera to the server. In S2912, the absolute position information of the player of interest is received from the server. In S2913, the software converts the absolute position information of the player of interest received from the server into relative position information from the seat position of the camera terminal, and displays the relative position information on the display unit of the camera terminal with a mark such as a frame or an arrow.

That is, the positions of the player of interest can be sequentially displayed. In S2914, it is determined whether or not the imaging (or monitoring) of the player of interest is finished, and, if the imaging (or monitoring) of the player of interest is finished, the flow proceeds to S2901. If the imaging (or monitoring) of the player of interest is continued in S2914, the flow proceeds to S2911, the information of the player of interest is sent to the server again. In S2912, the absolute position information of the player of interest is received from the server, and imaging of the player of interest is continued.

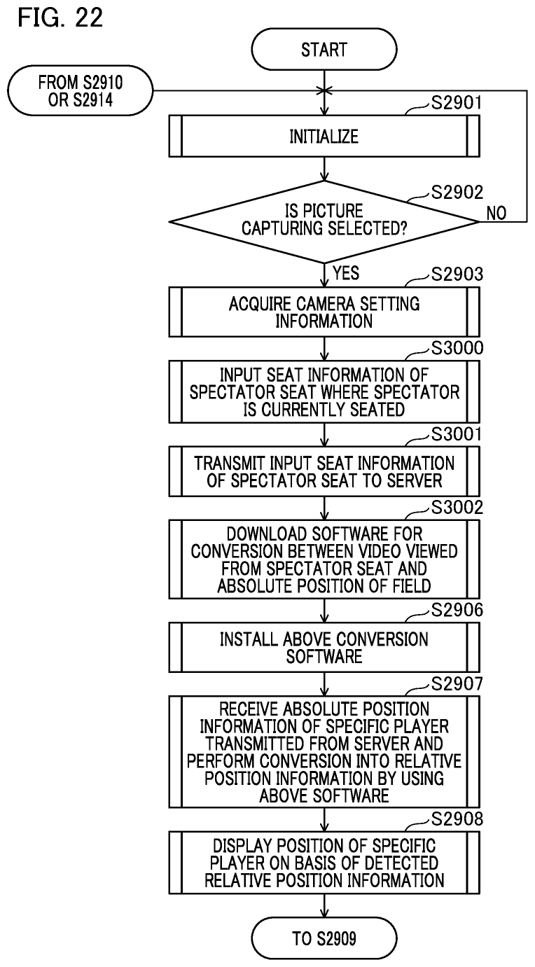

Next, FIG. 22 illustrates another example of a flow for displaying and tracking a player of interest by converting absolute position information into relative position information in the camera terminal side. In FIG. 22, seat information of a spectator is used to convert an absolute position into a relative position. In FIG. 22, since a step having the same reference sign as in FIGS. 20 and 21 indicates the same step, the description thereof will not be repeated.

In FIG. 22, in S3000, seat information of a spectator seat where a spectator is currently seated is input. As an input method here, a seat number, a QR code (registered trademark), or the like given to the seat may be read by the camera of the spectator, or the seat information may be input with a touch panel or a key.

In S3001, the seat information of the spectator seat that is input in S3004 is transmitted to the server. The server side optimizes software for converting an absolute position to a relative position on the basis of the seat position information. In S3002, the conversion software optimized on the basis of the seat information of the spectator seat is downloaded from the server.

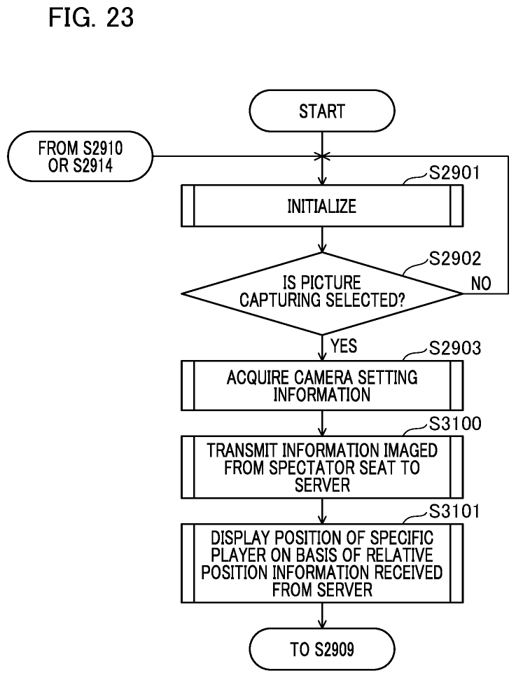

Next, FIG. 23 illustrates another example of the player of interest display tracking control flow in the camera side. In FIG. 23, a competition field or the like is imaged by a terminal such as a camera owned by a spectator, and the imaged information is transmitted to the server. The server converts absolute position information of the player of interest in the field into a relative position on the display screen of the camera terminal owned by the spectator on the basis of the imaged information, and then sends the relative position to the camera. Consequently, in the camera terminal, a mark indicating the position, such as a frame or arrow is superimposed on the image on the display unit on the basis of the relative position information from the server without downloading the software. Therefore, there is an advantage that a position where a player is located can be easily recognized in the camera terminal side.

In FIG. 23, since a step having the same reference sign as in FIGS. 20 and 21 indicates the same step, the description thereof will not be repeated. In FIG. 23, in S3100, information imaged from a spectator seat where a spectator is currently seated is sent to the server. The server recognizes a default absolute position of a specific player with a plurality of cameras for the server. A video captured by the spectator is received, and absolute position information of the specific player is converted into relative position information for viewing the player on a terminal such as a camera owned by the spectator on the spectators seat on the basis of the received video. In S3101, the relative position information of the specific player sent from the server is received, and the position of the specific player is displayed on the terminal such as a camera on the basis of the relative position information of the specific player. Thereafter, the flow proceeds to step S2909 in FIG. 21.

As described above, since a position of a player of interest can be displayed on a terminal side such as a camera in a timely manner, a spectator or a professional photographer does not lose sight of the player of interest and can reliably image an important moment.

Although the description has been made with the example of one player of interest, the number of player of interests may be plural. Player of interests may be switched on the way. All players participating in a game may be player of interests. A video or an image includes not only moving images but also still images. The description has focused on pursuing and tracking a player of interest.

However, instead of pursuing only the player of interest, information regarding a player who has or receives a ball may be transmitted to a professional photographer or spectator to be displayed. In the above Embodiment, the example of tracking a player has been described, but, needless to say, the present disclosure is applicable to a system of tracking a person such as a criminal by using a plurality of surveillance cameras. Alternatively, the present disclosure is applicable not only to a person but also to a system for tracking a specific car in car racing or the like or a system for tracking a horse in horse racing or the like. In the Embodiment, the example in which a player of interest is designated by a camera terminal or the like has been described, but the server side may be able to designate the player of interest.

In international competitions, privileges are often given to some spectators, sponsors, or the like, but, in the present Embodiment, a level of value added from the server to terminals such as cameras may be changed depending on such privileges or contract levels. This level-specific control can be realized by entering a password, or the like, and thus professional photographers with special contracts can acquire high-value videos or various information inside and outside the ground by entering a password, resulting in taking pictures with higher commercial value.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

A computer program that realizes some or all of the types of control in the present disclosure as functions of the above-described Embodiment may be supplied to an image processing apparatus or the like via a network or various storage media. Then, a computer (or a CPU, an MPU, or the like) in the image processing apparatus or the like may read and execute the program. In that case, the program and a storage medium storing the program fall within the present disclosure.

What is claimed is:

1. An image processing apparatus comprising:
at least one processor or circuit configured to function as:
a display unit configured to display an image:
a selection unit configured to select a specific target from the image displayed on the display unit;
a designation information generation unit configured to generate designation information regarding the specific target selected by the selection unit;
a transmission unit configured to transmit the designation information generated by the designation information generation unit and a predetermined password to a server;
an acquisition unit configured to acquire position information of the specific target that is generated by the server on the basis of the designation information and the password from the server; and
a control unit configured to display additional information based on the position information of the specific target acquired by the acquisition unit on the display unit.

2. The image processing apparatus according to claim 1, wherein the control unit displays a position of the specific target on a display screen of the display unit as the additional information on the basis of the position information.

3. The image processing apparatus according to claim 1, wherein the server generates the position information of the specific target on the basis of a result of recognizing the specific target in a video from a camera and transmits the position information to the image processing apparatus.

4. The image processing apparatus according to claim 2, wherein the server generates the position information on the basis of a result of image recognition of the specific target and transmits the position information to the image processing apparatus.

5. The image processing apparatus according to claim 2, wherein the server generates the position information of the specific target on the basis of a result of recognizing a signal from a position sensor included in the specific target.

6. The image processing apparatus according to claim 5, wherein the additional information includes at least one of a frame, a cursor, and regions having different colors or brightness.

7. The image processing apparatus according to claim 6, wherein the additional information indicates a direction in which the specific target is located when viewed from a screen if the specific target is outside the screen.

8. The image processing apparatus according to claim 7, wherein the additional information indicates a degree to which the specific target is deviated from the screen.

9. The image processing apparatus according to claim 8, wherein the additional information indicates the degree to which the specific target is deviated from the screen with a length or a thickness of an arrow.

10. The image processing apparatus according to claim 8, wherein the additional information indicates the degree to which the specific target is deviated from the screen with a number or a scale.

11. The image processing apparatus according to claim 4, wherein the server performs image recognition of a number worn by the specific target or a shape of a part or a whole of the specific target.

12. The image processing apparatus according to claim 1, wherein the server generates the position information of the specific target on the basis of a result of image recognition of the specific target in videos from a plurality of cameras, and transmits the position information to the image processing apparatus.

13. The image processing apparatus according to claim 1, further comprising:
tracking unit configured to track the specific target after the position information of the specific target is acquired by the acquisition unit.

14. The image processing apparatus according to claim 13, wherein the tracking unit executes tracking of the specific target after the position information of the specific target is acquired from the server, and requests the server to transmit the position information when the tracking fails.

15. The image processing apparatus according to claim 1, wherein the server acquires in advance a video of an entire field where the specific target is present and uses the video for generating the position information.

16. The image processing apparatus according to claim 15, wherein the server generates relative position information when the specific target is viewed from the image processing apparatus on the basis of the position information of the specific target in the field.

17. The image processing apparatus according to claim 15, wherein the server transmits first position information of the specific target in the field to the image processing apparatus, and the image processing apparatus generates relative position information when the specific target is viewed from the image processing apparatus on the basis of the first position information.

18. The image processing apparatus according to claim 1, wherein the selection unit selects a plurality of specific targets.

19. The image processing according to claim 1, wherein the server also sends information other than the position information of the specific target to the image processing apparatus on the basis of the password and the designation information.

20. The image processing apparatus according to claim 1, wherein the password has a plurality of levels, and the server changes information regarding the specific target to be sent to the image processing apparatus on the basis of a level of the password and the designation information.

21. The image processing apparatus according to claim 1, further comprising:
download unit configured to download software for converting absolute position information into relative position information.

22. An image processing method comprising:
displaying an image;
selecting a specific target from the image displayed in the displaying;
generating designation information regarding the specific target selected in the selecting;
transmitting the designation information generated in the designation information generating and a predetermined password to a server;
acquiring position information of the specific target that is generated by the server on the basis of the designation information and the password from the server; and
controlling to display additional information based on the position information of the specific target acquired in the acquiring.

23. A non-transitory computer-readable storage medium configured to store a computer program to execute an image processing method comprising:
displaying an image:
selecting a specific target from the image displayed in the displaying;
generating designation information regarding the specific target selected in the selecting;
transmitting the designation information generated in the designation information generating and a predetermined password to a server:
acquiring position information of the specific target that is generated by the server on the basis of the designation information and the password from the server; and
controlling to display additional information based on the position information of the specific target acquired in the acquiring.
